(19) United States
(12) Patent Application Publication
(10) Pub. No.: US 2009/0260784 A1
(43) Pub. Date: Oct. 22, 2009

(54) Heat Exchanger and Method of Forming a Heat Exchanger

(76) Inventor: Allan Stikeleather, Canton, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 12/424,956

(22) Filed: Apr. 16, 2009

Related U.S. Application Data
(60) Provisional application No. 61/046,742, filed on Apr. 21, 2008.

(51) Int. Cl. F28F 13/18; B23P 15/26

(52) U.S. Cl. 165/133; 29/890.046

(57) ABSTRACT

A heat exchanger includes a tubular portion configured to carry a first heat exchange medium and a finned portion coupled to the tubular portion. The tubular portion includes a tube and a coating disposed on the tube. The finned portion includes a fin strip disposed in a groove formed in the coating to secure the fin to the tube portion.

### CROSS-REFERENCE TO RELATED APPLICATIONS

This application claims the benefit of U.S. Provisional Application No. 61/046,742, filed Apr. 21, 2008, the entire disclosure of which is incorporated by reference.

### FIELD

The present disclosure relates to heat exchangers and a method of forming a heat exchanger.

### BACKGROUND

Generally, heat exchangers are configured for efficient heat transfer from one medium to another. For example, heat exchangers include automobile radiators, refrigeration units, space heating units. Heat exchangers may be used in electric generating plants, natural gas processing and/or chemical plants. Heat exchangers may be further used in waste heat recovery for heating applications.

### BRIEF DESCRIPTION OF THE DRAWINGS

Features and advantages of the present disclosure will be apparent from the following description of embodiments consistent therewith, which description should be considered in conjunction with the accompanying drawings, wherein:

FIGS. 1A through 1C are a side view, a cross-sectional view and a perspective view, respectively, of an exemplary heat exchanger;

FIGS. 2A and 2B are block flow diagrams illustrating exemplary methods of forming a heat exchanger consistent with the present disclosure;

FIG. 3 is a side view of a heat exchanger tubular portion illustrating a groove; and

FIGS. 4A and 4B are perspective views of two exemplary heat exchanger assemblies consistent with the present disclosure.

### DESCRIPTION

The present disclosure is directed to a heat exchanger, a method of forming the heat exchanger and a heat exchanger assembly. The heat exchanger may include a tubular portion and a finned portion coupled to the tubular portion. The heat exchanger tubular portion may define a passageway. The tubular portion may include a tube, e.g., an inner tube, constructed of a first material. The tubular portion may include a coating, e.g., an external coating, on a surface of the tube. The coating may include a second material, different from the first material. The first material and the second material may be thermally conductive. The finned portion may include a fin strip. A groove may be formed in the coating, configured to receive the finned portion. The fin strip may be inserted in the groove and a portion of the coating adjacent the groove and/or the groove may be deformed to “pinch” the fin strip to provide a firm coupling between the finned portion and the coating. The first and/or second material may have anti-corrosive properties.

Heat exchangers are generally configured to transfer heat from a first medium to a second medium without direct contact between the first and second media. For example, for an automobile radiator (i.e., heat exchanger), engine coolant may be the first medium and atmospheric air may be the second medium. In another example, for a boat engine heat exchanger, engine coolant may be the first medium and water, e.g., sea water, may be the second medium. The engine coolant may be heated by combustion in the engine as the coolant is pumped through the engine. The coolant may then be cooled as it flows through the heat exchanger. In an automobile, cooling may be facilitated by airflow through the radiator due to motion of the vehicle and/or operation of a fan. In a boat, cooling may be facilitated by pumping sea water, for example, into and out of a housing that may contain the heat exchanger. In this manner, heat produced by engine combustion may be transferred to the coolant and from the coolant to the atmosphere and/or a body of water.

A heat exchanger may include a tubular portion and, typically, a finned portion coupled to the tubular portion. In an automobile, the radiator may include a finned portion coupled to the tubular portion and may be configured to allow airflow between and around the tubular portion. A boat engine heat exchanger may also include a finned portion coupled to the tubular portion. The boat engine heat exchanger may be disposed in an interior volume of a housing or shell that includes an inlet port and an outlet port. The ports may be configured to allow cooling water to flow into and out of the interior volume of the shell. The heat exchanger and shell may be configured to allow flow of cooling water along, around and/or across the tubular portion and/or finned portion. For example, the finned portion may be coupled to an exterior surface of the tubular portion to facilitate heat transfer between the two media.

Optimum design of heat exchangers depends on a number of factors. Some may be selectable by a designer, e.g., a material, and others may be defined by an application, e.g., cost. For example, the first and/or second medium may be defined by the application, e.g., need for a relatively large volume of a cooling medium and availability of sea water as the cooling medium. A medium may be corrosive and/or may interact with potential heat exchanger tube materials. The first and second media may differ in their corrosive and/or interaction properties. It may therefore be desirable to construct a heat exchanger with a first material exposed to the first medium and a second material exposed to the second medium.

To facilitate heat transfer, heat exchanger materials may generally include thermally conductive materials. Additionally or alternatively, it is desirable to maximize a contact area between a medium and a heat exchanger. To increase heat transfer efficiency, a surface area of a wall of the heat exchanger tubular portion may be increased. For example, a wall of the heat exchanger tubular portion may be coupled to a finned portion. For example, the finned portion may be in integral contact with an external surface of the heat exchanger tubular portion and may be configured to increase the contact area of the medium external to the heat exchanger tubular portion and the tubular portion exterior surface.

In some configurations, the heat exchanger tubular portion, e.g., tube, may include a first material and the finned portion, e.g., fin strip, may include a second material. The fin strip material may be exposed to a first medium. The tube material may be exposed to the first medium, e.g., between fins, and to a second medium. The tube material may be susceptible to corrosion and/or erosion based on exposure to the first medium. Additionally or alternatively, it may be difficult to securely couple the fin strip to the tube because of material differences. It may therefore be desirable to provide a method of constructing a heat exchanger that reduces or eliminates exposure of the tube material to the first medium and facilitates securely coupling the fin strip to the tubular portion while at least maintaining heat transfer efficiency between the media.

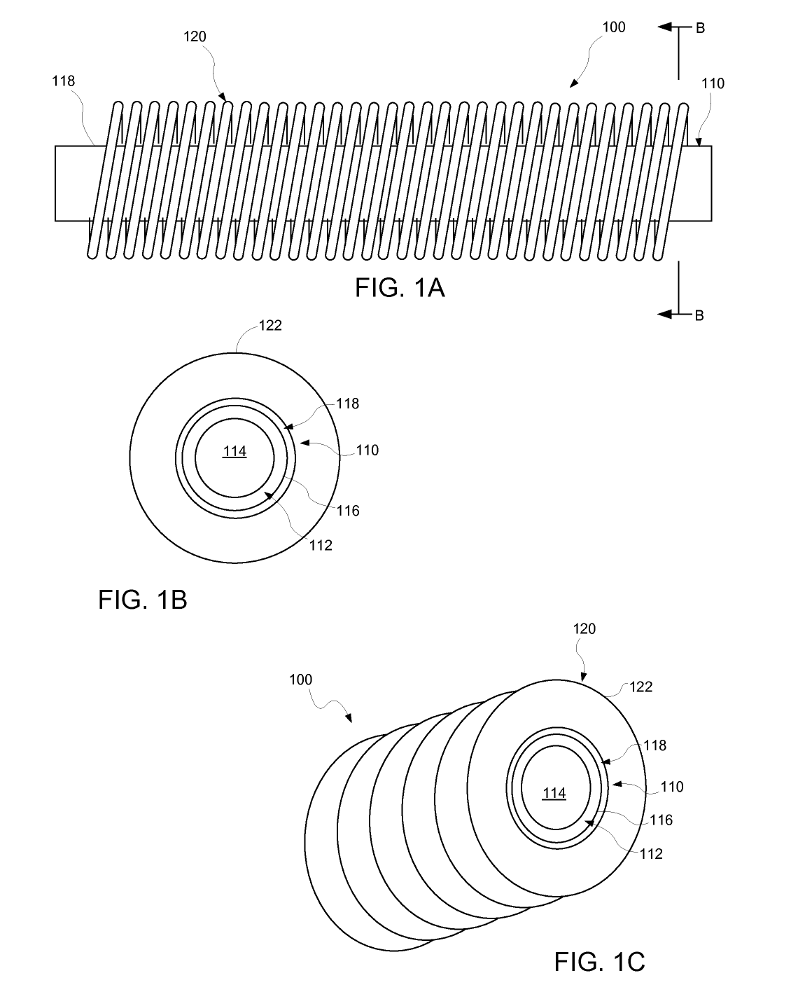

FIGS. 1A through 1C illustrate an exemplary embodiment of a heat exchanger 100 consistent with the present disclosure. FIG. 1A is a side-view, FIG. 1B is a cross-sectional view and FIG. 1C is a perspective view. In general, the heat exchanger 100 facilitates heat transfer between a first heat transfer medium within and/or flowing through a passageway 114 defined by a heat exchanger tubular portion 110 and a second heat transfer medium surrounding and/or flowing along, across and/or around the heat exchanger 100. For example, the passageway 114 may have a generally circular cross-section. The first heat transfer medium and the second heat transfer medium may be fluid heat transfer media, such as gasses, liquids, etc. Furthermore, the first heat transfer medium within the passageway 114 may be different than the second heat transfer medium moving or flowing over and/or around the heat exchanger 100.

The heat exchanger 100 may generally include the tubular portion 110 and a finned portion 120 coupled to the tubular portion 110. The tubular portion 110 may include a tube 112 and a coating 118 applied to a surface of the tube 112. For example, the coating 118, e.g., outer coating, may be applied to an exterior surface 116 of the tube 112, e.g., inner tube. The finned portion 120 may include a fin strip 122 that may be helically, longitudinally and/or radially arranged. As used herein, “strip” may be understood as a three-dimensional solid with a depth less than a width and a length greater than the width. Generally, the depth may be relatively small compared to the width and the length may be relatively large compared to the width. The particular dimensions may depend, at least in part, on a size of the heat exchanger tubular portion 110, including a diameter and a length.

The tube 112, coating 118 and fin strip 122 may be formed of any appropriate material. The tube 112 material, the coating 118 material and the fin strip 122 material may or may not all be the same. Each material may be selected based, at least in part, on temperature, e.g., operating and/or manufacturing, properties of the heat transfer media to which the material may be exposed, e.g., corrosion and/or potential for interaction between the media and the material, operating pressures and/or other factors known to those skilled in the art. For example, the tube 112 may be formed of a metal, the coating 118 may be a metal coating applied to a surface, e.g., exterior surface 116 of the tube 112 and/or the fin strip 122 may be a strip formed of a metal. Metals may include steel, steel alloy, copper, copper alloy, aluminum and/or aluminum alloy. For example, the tube 112 may be formed from steel, the coating 118 may include aluminum and/or the finned portion 120 may include aluminum. Although embodiments described herein may refer to a tube 112 formed of steel, a coating 118 of aluminum and a finned portion 120 formed of aluminum, it is to be understood that the tube 112, coating 118 and/or finned portion 120 may be formed of other appropriate materials.

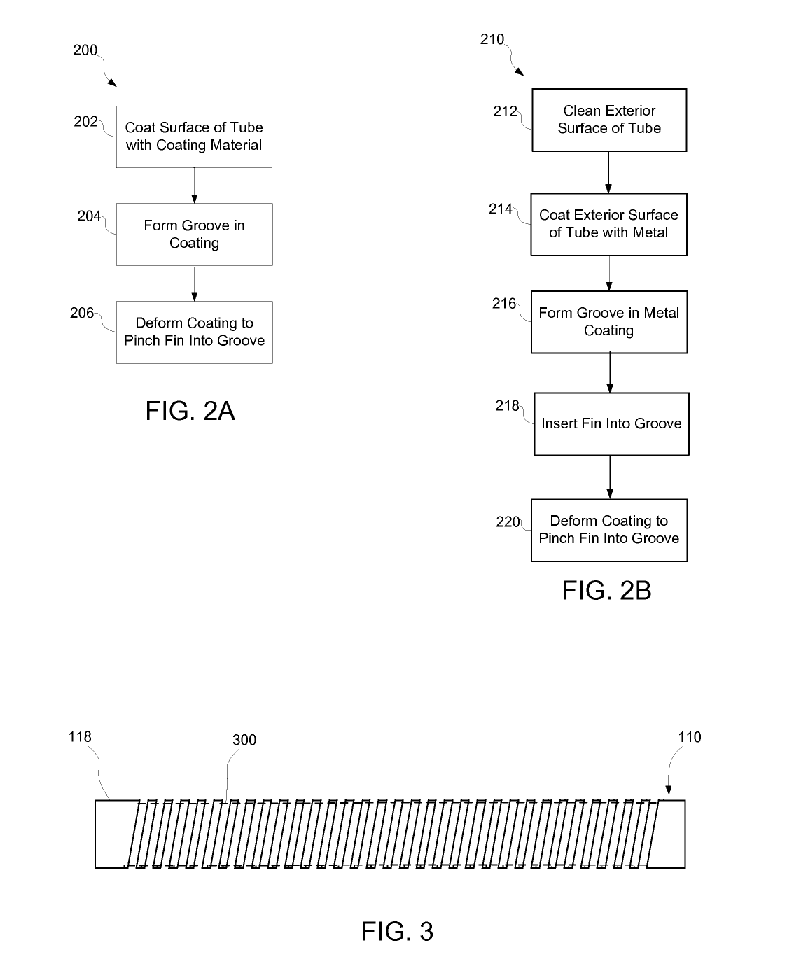

FIGS. 2A and 2B are process flow charts 200, 210 for constructing a heat exchanger. The process flow charts 200, 210 illustrate a particular sequence of steps. It can be appreciated, however, that the sequence of steps merely provides examples of how the general functionality described herein can be implemented. Further, the sequence of steps does not have to be executed in the order presented unless otherwise indicated.

FIG. 2A is an exemplary process flow chart 200 for constructing a heat exchanger, e.g. heat exchanger 100. First, a surface of a tube may be coated 202 with a coating material. A groove may then be formed 204 in the coating. The coating may then be deformed to pinch 206 a fin into the groove.

FIG. 2B is another exemplary embodiment 210 for constructing a heat exchanger, e.g., heat exchanger 100. First, a surface, e.g., exterior surface 116, of a tube, e.g., tube 112, may be cleaned 212. The exterior surface 116 of the tube 112 may be cleaned using an appropriate cleaning method. The cleaning method used may be based, at least in part, on the tube 110 material. Cleaning methods may include chemical cleaning processes and/or mechanical cleaning processes. Advantageously, cleaning a surface of a tube, e.g., tube 112, may facilitate bonding a coating material to the surface and may thereby provide corrosion protection for the tube.

Chemical cleaning processes may include solvent cleaning processes and/or aqueous cleaning processes. Solvent cleaning processes may include cold cleaning, e.g., wiping a liquid solvent on a surface to be cleaned, or vapor cleaning where a solvent is heated to a vapor, condenses on the surface to be cleaned, dissolves contaminants and leaves the surface with the contaminants. Aqueous cleaning processes may include cleaning a surface using a solution of water and detergents. The solution may be sprayed on the surface and/or the element to be cleaned, e.g., tube 112, may be immersed in the solution, with or without agitation while immersed.

Mechanical cleaning processes may include liquid and/or abrasive blasting. Liquid blasting may include propelling a spray or stream of a liquid, e.g., water, under pressure onto a surface using a nozzle to control a spread of the spray or stream. Abrasive blasting may include propelling particles at relatively high speed onto a surface to be cleaned. The particles may be suspended in an air stream for travel to the surface. Particles may include sand, plastic media of varying hardness, shape and size, metal particles, pellets or shots of varying shape and size, and/or other materials such as sodium bicarbonate. Liquid blasting and abrasive blasting may be combined, e.g., spraying sodium bicarbonate and water onto a surface. The particle composition, size and shape may be selected based, at least in part, on the surface material.

For example, for cleaning a tube 112 formed of a metal, e.g., steel, abrasive blasting, e.g., shot blasting, may be used to clean the exterior surface 116 of the tube 112. Abrasive blasting, such as shot blasting, may result in a relatively rougher exterior surface 116 of the tube 112. Advantageously, the relatively rougher surface may facilitate coupling, e.g., bonding, a coating, e.g., coating 118, to the exterior surface 116 of the tube 112.

Returning to FIG. 2B, the exterior surface of the tube, e.g., tube 112, may be coated 214 with a material. The exterior surface 116 of the tube 112 may be coated using an appropriate coating method. The coating method may be based, at least in part, on the tube 112 material and/or the coating material. Coating methods may include spraying, electroplating, dipping and/or drawing. Additionally or alternatively, the coating method may be based on a resulting concentricity of the coating and the tube 112, i.e., thickness of the coating over the surface of the tube 112. For example, a depth of a groove may depend on the concentricity of the coating and the tube. For example, spraying a coating may provide superior concentricity when compared to dipping. Dipping may include immersing a tube into a bath of coating material, e.g., molten metal. For example, dipping may be used with steel tubes and aluminum or aluminum alloy coating material. In electroplating, the tube may be configured as a cathode in an electrolyte, including the coating material. The coating material may then be deposited on a surface of the tube. Examples of coating material that may be deposited by electroplating include copper and copper alloys.

The spraying coating method may include thermal spraying. In thermal spraying, a coating material, e.g., a metal, may be melted and relatively small droplets of the melted coating material may be propelled onto a surface to be coated. Once on the surface, the droplets may consolidate and cool to form a coating. Prior to melting, and depending on the coating method, the coating material may be in the form of powder, rod, wire and/or liquid. Depending on the form of the coating material, the coating material may be melted using a flame and/or electrical energy. The melted coating material may be propelled to the surface using a flame, a compressed gas and/or compressed air.

For example, for coating a tube, e.g., tube 112, with a metal, e.g., aluminum or an aluminum alloy, a twin wire spray method may be used. In a twin wire spray method, a coating material may initially be in the form of two wires. Each wire may be coupled to a power source, with one wire coupled to the positive terminal and the other wire coupled to the negative terminal. An end of each wire may be disposed in a nozzle of a spray gun. The ends of the wires may be positioned in relatively close proximity. The two wires may be energized, resulting in an electrical arc between the wires and melting the ends of the wires at the nozzle. The melted coating material may then be propelled onto the tube 112 by compressed air and/or compressed gas. The wires may be “fed” to the nozzle in a continuous manner (and consumed) until the entire tube 112 has been coated. The spray gun may move relative to the tube 112 and/or the tube 112 may move relative to the spray gun. For example, the spray gun may be substantially stationary while the tube 112 is advanced and/or rotated relative to the spray gun as the coating is being applied. Advantageously, the twin wire spray method may allow a coating of a controlled thickness and/or concentricity to be applied to the tube 112. For example, a coating of a controlled thickness may facilitate providing a coating with a thickness and/or concentricity adequate for corrosion protection and/or groove forming without consuming too much coating material and thereby increasing cost. For example, a relatively thick coating may facilitate deforming the coating to “pinch” a fin strip in the groove. Additionally or alternatively, the relatively thick coating may provide superior corrosion protection for the tube 112 compared to a relatively thin coating and/or no coating.

Returning to FIG. 2B and as illustrated in FIG. 3, once the coating 118 is applied to the tube 112 a groove, e.g., groove 300, may be formed 216 in the coating 118 along a length of the tubular portion 110. For example, the groove 300 may be helical, longitudinal and/or radial. The groove 300 may be formed using an appropriate method known to those skilled in the art. Groove forming methods may include machining methods using, for example, a milling machine and/or a lathe. The machining methods may further include computer numerical control (CNC) as known to those skilled in the art. For example, a tube, e.g., tubular portion 110, may be rotated and/or advanced while a cutting tool or cutter, positioned relative to the tubular portion 110, may remove material from the coating 118 thereby creating a groove. In another example, the tubular portion 110 may be rotated relative to the cutter and/or the cutter may move substantially parallel to a longitudinal axis of the tube. In this manner, a groove may be formed in the coating 118 of the tubular portion 110. The groove may be helical and/or a plurality of radial grooves may be created. In another example, the groove may be longitudinal, i.e., may have a long dimension parallel to the longitudinal axis of the tubular portion 110. A shape of the groove may depend on a style of the cutting tool. Cutting tool styles include diamond, round, square and triangular. A depth of the groove may also be controlled and may depend on a thickness of the coating 118.

As shown in FIG. 1A, for example, once the groove is formed 216, a fin strip, e.g., fin strip 122, may be inserted 218 into the groove 300. For example, the fin strip 122 may be helical. The fin strip 122 may be formed by an appropriate metal-forming method. Metal-forming methods may include forging and/or rolling. Forging may include mechanical and/or hydraulic pressing. For example, feedstock may be placed in a die and/or in a press that is configured to form the feedstock into a strip and/or a helical strip, using compressive force. Rolling may include placing feedstock between two opposing circular rolls that rotate in opposite directions and are configured to reduce a cross section of the feedstock, i.e., resulting in a strip. The strip may then be formed into a helical fin strip.

The fin strip 122 may then be inserted 218 into the groove. For example, for a helical and/or radial groove, the fin strip 122 may be inserted into the groove as the tubular portion 110 is being rotated. The tubular portion may also be advanced relative to the fin strip as the tubular portion 110 is being rotated and the fin strip 122 is inserted into the groove 300.

The fin strip 122 may be secured to the tubular portion 110 by pinching or otherwise deforming 220 the coating 118, e.g. between successive fins, to establish an interference fit between the fin strip 122 and the deformed coating 118. The deformation of the coating 118 to secure the fin strip 122 may be performed, for example, by an appropriate roller that contacts and presses the coating 118 between the fins to deform the coating 118. For example, for a helical groove and helical fin strip, the roller may contact and press the coating between the fins as the tubular portion 110 is rotated and advanced. In this manner the coating 118 may be deformed to create an interference fit between the deformed coating and the finned portion 120, i.e., the coating 118 may “pinch” the fin strip 122 thereby holding the finned portion 120 in place.

A heat exchanger constructed according to a process consistent with the present disclosure may provide improved heat transfer efficiency. For example, steel may have a lower thermal conductivity than aluminum or copper. A heat exchanger constructed of steel may not transfer heat as well as a heat exchanger constructed with a tube of steel and a coating of, e.g., aluminum and/or copper.

Coating the tube 112 prior to forming the groove 300 and/or inserting the fin strip 122, may facilitate forming the groove 300. For example, a coating material, e.g., aluminum, may generally be softer, i.e., may be easier to cut, than a tube material, e.g., steel. Additionally or alternatively, the coating material may be applied to achieve a thickness using, e.g., the twin-wire spraying method, and may therefore provide superior corrosion protection for the heat exchanger 100.

In some embodiments, the material of the fin strip 122 and the coating 118 material may be similar, e.g., may each be aluminum or an aluminum alloy. Similar materials may enhance a bond between the finned portion 120 and the coating 118.

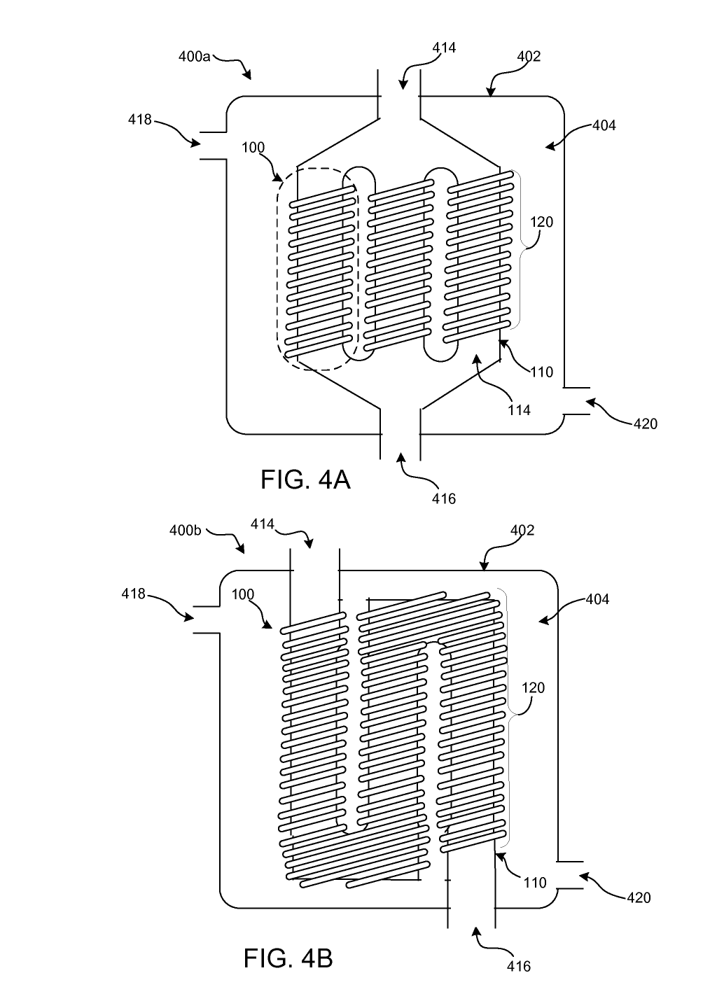

FIGS. 4A and 4B illustrate two exemplary heat exchanger assemblies 400a, 400b. Those skilled in the art should recognize that a number of details have been omitted from the illustrated heat exchanger assemblies 40a, 400b for ease of illustration. Those skilled in the art should further recognize that locations of various features, e.g. inlet and outlet ports, are merely illustrative and other configurations are possible. Additionally, the configurations of heat exchanger tubular portions and finned portions shown are for illustration purposes. A heat exchanger assembly, consistent with the present disclosure, may have other configurations.

The heat exchanger assemblies 400a, 400b may include a housing 402 (e.g., shell) and a heat exchanger 100 coupled to the housing. The heat exchanger 100 may be at least partially disposed in the housing 402. For example, the housing 402 may define an interior volume 404 and the heat exchanger 100 may be disposed therein. Each heat exchanger 100 may be in fluid communication with a tube inlet port 414 and a tube outlet port 416. As used herein, “fluid” may be understood to include liquids and/or gasses. The tube inlet port 414 and tube outlet port 416 may extend from the housing interior volume 404 to the housing 402 exterior. The tube inlet and outlet ports 414, 416, may be configured to isolate (i.e., prevent fluid communication between) a first heat transfer medium, present and/or flowing within the tube inlet and outlet ports 414, 416, from a second heat transfer medium that may be present and/or flowing in the interior 404 of the housing 402. For example, the tube inlet port 414 may be coupled to a source of a first fluid (not shown). The tube outlet port 416 may be coupled to a receptacle for the first fluid (not shown). The housing 402 may include a housing inlet port 418 and a housing outlet port 420. Each housing port 418, 420 may couple the housing interior volume 404 to the housing exterior. For example, the housing inlet port 418 may be coupled to a source of a second fluid.

For example, a first fluid may flow from the source of the first fluid into the tube inlet port 414. The tube inlet port 414 may be configured as a manifold, e.g., as shown in FIG. 4A. The first fluid may then flow out of the tube inlet port 414 into each heat exchanger tube passageway 114, along each passageway 114 and out of each heat exchanger tube passageway 114. A second fluid may flow into the housing inlet port 418 and into the housing interior volume 404. The second fluid may then flow along, across, and/or around each heat exchanger 100. Heat may be transferred between the first fluid and the second fluid as the first fluid flows in the heat exchanger tube passageway 114. The first fluid may then flow into the tube outlet port 416, out of the housing 402 then out of the tube outlet port 416. The tube outlet port 416 may be configured as a manifold, e.g., as shown in FIG. 4A. The second fluid may then flow into the housing outlet port 420 and out of the housing 402. The tubular portion 110 may be configured to isolate the first fluid from the second fluid, i.e., to prevent mixing of the first and second fluids while allowing heat transfer between the fluids. The housing 402 may be configured to contain the second fluid and to maintain contact between the second fluid and each heat exchanger 100.

According to one aspect of the present disclosure therefore, there is provided a heat exchanger including: a tubular portion configured to carry a first heat exchange medium, the tubular portion including a tube and a coating disposed on the tube; and a finned portion coupled to the tubular portion, the finned portion including a fin strip disposed in a groove formed in the coating.

According to another aspect of the present disclosure there is provided a method of forming a heat exchanger including: applying a coating to a tube; forming a groove in the coating; inserting a fin strip in the groove; and deforming the groove to provide an interference fit between the fin strip and the coating to secure the fin strip in the groove.

According to another aspect of the present disclosure therefore, there is provided a heat exchanger assembly including: a housing and a heat exchanger coupled to the housing. The heat exchanger includes: a tubular portion configured to carry a first heat exchange medium, the tubular portion including a tube and a coating disposed on the tube; and a finned portion including a fin strip disposed in a groove formed in the coating.

The invention herein has been set forth through the description of various embodiments consistent therewith. It should be recognized that any aspect or feature of any embodiment described herein may be used in combination with any other aspects or features of the various embodiments. The described embodiments are susceptible to numerous modifications and variations without departing from the invention herein, and should therefore not be construed as limiting the invention.

What is claimed is:

1. A heat exchanger comprising:
a tubular portion configured to carry a first heat exchange medium, said tubular portion comprising a tube and a coating disposed on said tube; and
a finned portion coupled to said tubular portion, said finned portion comprising a fin strip disposed in a groove formed in said coating.

2. A heat exchanger according to claim 1, wherein said groove is helical and said finned portion is helically disposed about said tubular portion.

3. A heat exchanger according to claim 1, wherein said coating is disposed on an exterior surface of said tube.

4. A heat exchanger according to claim 1, wherein said groove is deformed, providing an interference fit between said fin strip and said coating, securing said fin strip in said groove.

5. A heat exchanger according to claim 1, wherein said finned portion comprises aluminum.

6. A heat exchanger according to claim 1, wherein said coating comprises aluminum, said tube comprises steel, and said finned portion comprises aluminum.

7. A method of forming a heat exchanger comprising:
applying a coating to a tube;
forming a groove in said coating;
inserting a fin strip in said groove; and
deforming said groove to provide an interference fit between said fin strip and said coating to secure said fin strip in said groove.

8. A method according to claim 7, wherein said applying a coating comprises spraying.

9. A method according to claim 7, wherein said forming said groove comprises machining.

10. A method according to claim 7, wherein said deforming said groove comprises rolling said coating.

11. A method according to claim 7, further comprising cleaning said tube using abrasive blasting.

12. A method according to claim 7, wherein said groove is helical.

13. A method according to claim 7, wherein said coating comprises aluminum, said tube comprises steel, and said fin strip comprises aluminum.

14. A heat exchanger assembly comprising:
a housing; and
a heat exchanger coupled to said housing, said heat exchanger comprising:
a tubular portion configured to carry a first heat exchange medium, said
tubular portion comprising a tube and a coating disposed on said tube; and
a finned portion comprising a fin strip disposed in a groove formed in said coating.

15. A heat exchanger assembly according to claim 14, wherein said housing defines an interior volume configured to carry a second heat exchange medium and said heat exchanger is disposed within said interior volume.

16. A heat exchanger assembly according to claim 14, wherein said groove is helical and said finned portion is helically disposed about said tubular portion.

17. A heat exchanger assembly according to claim 14, wherein said coating is disposed on an exterior surface of said tube.

18. A heat exchanger assembly according to claim 14, wherein said groove is deformed, providing an interference fit between said fin strip and said coating, securing said fin strip in said groove.

19. A heat exchanger assembly according to claim 14, wherein said finned portion comprises aluminum.

20. A heat exchanger assembly according to claim 14, wherein said coating comprises aluminum, said tube comprises steel, and said finned portion comprises aluminum.
